(19) United States
(12) Patent Application Publication
(10) Pub. No.: US 2010/0037702 A1
(43) Pub. Date: Feb. 18, 2010

(54) FLOWMETER

(75) Inventors: Karl-Heinz RACKEBRANDT, Adelebsen (DE); Klaus Schäfer, Hannoversch Münden (DE)

Correspondence Address: BUCHANAN, INGERSOLL & ROONEY PC, POST OFFICE BOX 1404, ALEXANDRIA, VA, 22313-1404, US

(73) Assignee: ABB Technology AG, Zurich (CH)

(21) Appl. No.: 12/543,294

(22) Filed: Aug. 18, 2009

(30) Foreign Application Priority Data
Aug. 18, 2008 (DE) 10 2008 038 163.2

(51) Int. Cl. G01F 1/58

(52) U.S. Cl. 73/861.12

(57) ABSTRACT

A flowmeter includes a measuring tube made of plastic or at least a plastic lining. The plastic measuring tube or the measuring tube internally lined with plastic is provided with a layer sequence of insulating plastic layers and conductive layers to comprehensively diagnose a state of performance of the flowmeter.

### RELATED APPLICATIONS

This application claims priority under 35 U.S.C. §119 to German Patent Application No. 10 2008 038 163.2 filed in Germany on Aug. 18, 2008, the entire content of which is hereby incorporated by reference in its entirety.

### FIELD

The present disclosure relates to a flowmeter having a measuring tube made of at least a plastic lining.

### BACKGROUND INFORMATION

Flowmeters with different measuring principles are known. Chemically neutral to chemically aggressive media, and even occasionally abrasive media, are used as a measurement medium whose flow rate is to be determined. Together with chemical intervention, abrasive measurement media can not only contaminate the medium but also destroy electrically active surfaces, such as the surfaces of electrodes of a flowmeter, for example. Measuring tubes made of plastic or at least linings made of plastic, so-called liners, are often used for chemical resistance. However, progressive abrasion over the service life of a measuring device is a factor for consideration.

EP 1 193 474 A1 discloses flowmeters having a plastic measuring tube.

Against the problem described above, diagnosis of the state of the inner surface of the plastic can be an important consideration.

### SUMMARY

An exemplary embodiment of the present disclosure provides a flowmeter having a measuring tube internally lined with plastic. The exemplary flowmeter comprises at least one electrode arranged to be in contact with a measurement substance to be measured. In addition, the exemplary flowmeter comprises a plurality of layers arranged in a layered sequence of insulating plastic layers and conductive layers.

### BRIEF DESCRIPTION OF THE DRAWINGS

Additional features, advantages and refinements of the present disclosure are described below in greater detail with reference to exemplary embodiments illustrated in the drawings, in which:

FIG. 1 shows a layer sequence for an exemplary plastic tube according to at least one embodiment,

FIG. 2 shows a layer sequence for an exemplary metal tube according to at least one embodiment, and

FIG. 3 shows a side view of an exemplary measuring tube for a flowmeter according to at least one embodiment.

### DETAILED DESCRIPTION

Exemplary embodiments of the present disclosure provide a flowmeter which enables diagnosis or self-diagnosis of the state of the inner surface of the measuring tube.

According to an exemplary embodiment, a plastic measuring tube or a measuring tube internally lined with plastic is provided with a layer sequence of insulating plastic layers and conductive layers. The layer sequence makes it possible to diagnose the inner surface.

According to an exemplary embodiment, the conductive layers can comprise at least one metal layer.

According to an exemplary embodiment, the conductive layers can comprise at least one electrically conductive plastic layer.

According to an exemplary embodiment, the innermost layer arranged next to the measuring tube is an electrically insulating plastic layer, and the next layer lying over the innermost layer is a conductive layer. The conductive layer is contact-connected and is connected to an electric circuit or sources (e.g., battery or constant current supply) which signal an electrical short circuit to the measurement medium in the event of abrasion of the internal insulation layer. In this manner, abrasion detection can be accomplished in a very reliable manner.

However, it should be mentioned in this case that the definition of the term abrasion is broad. The term abrasion is used herein to mean not only creeping abrasion which occurs over a long service life but also damage which may occur if relatively large particles occasionally flow through the measurement medium. These may give rise to impacts and thus instantaneous damage to the inner layer of the measuring tube. This damage is likewise intended to be included in the definition of abrasion as used herein.

Another advantageous embodiment provides that the measuring tube, to the inside of which the alternating conductive and insulating layers are applied, is constituted by a metal tube. This makes it possible to use the advantageous statics and compressive strength of a metal tube.

According to another exemplary embodiment, the measuring tube to the inside of which the alternating conductive and insulating layers are applied, is constituted a plastic tube. This makes it possible to use the structural advantages of a plastic tube which is simple to handle and produce.

According to an advantageous embodiment, an insulation layer is arranged under conductive layer and a further conductive diagnostic layer is arranged under insulation layer. This enables a sensitive and diagnostically multilayer structure which can gradually determine progressive abrasion in thin layer sequences.

According to an exemplary embodiment, when a metal measuring tube is used, a further insulation layer can be arranged between the further conductive diagnostic layer and the inner wall of the basic measuring tube.

According to the exemplary embodiment employing plastic measuring tube, the further conductive diagnostic layer can be arranged directly on the inner wall of the measuring tube.

FIG. 1 shows a cross section of a plastic measuring tube of a flowmeter with an exemplary coating configuration according to at least one embodiment of the present disclosure. The measuring tube can be produced from plastic by means of injection-molding or extrusion with subsequent machining, for example. Electrodes for measuring the medium can be introduced into the plastic or lining. Such electrodes may be constituted by discrete electrodes, capacitive electrodes or conductive regions, for example. The form of construction according to exemplary embodiments the present disclosure is intended to combat defects which may be produced by progressive abrasion in the measuring tube.

On the one hand, the strength of the measuring tube may be reduced by abrasion and this may become critical particularly in the case of plastic tubes. An alternating layer sequence of a plurality of conductive layers 2, 4 and nonconductive layers 3, 5 also makes it possible to detect progressive, increasingly ablating abrasion by contact-connecting conductive layers which alternate in the depth profile. In accordance with this configuration a corresponding signal relating to the respective contact between the various conductive layers 2, 4 and the measurement medium, respectively, can be used to determine a particular depth of abrasion that is reached. According to an exemplary embodiment, the nonconductive layers 3, 5 may be constituted by insulating plastic layers, for example.

This configuration enables detection of the depth of abrasion when it is no longer possible to clean the measuring tube as a result of progressive abrasion. For example, the problem of the suspension of sterility in food and pharmaceutics applications can be recognized in this case.

The depth profile of the coating sequence, as illustrated in FIG. 1, indicates a first advance warning stage and, as abrasion progresses, a second abrasion warning stage. For example, the successively arranged conductive layers 2, 4 and/or nonconductive layers 3, 5 are can constitute the respective warning stages.

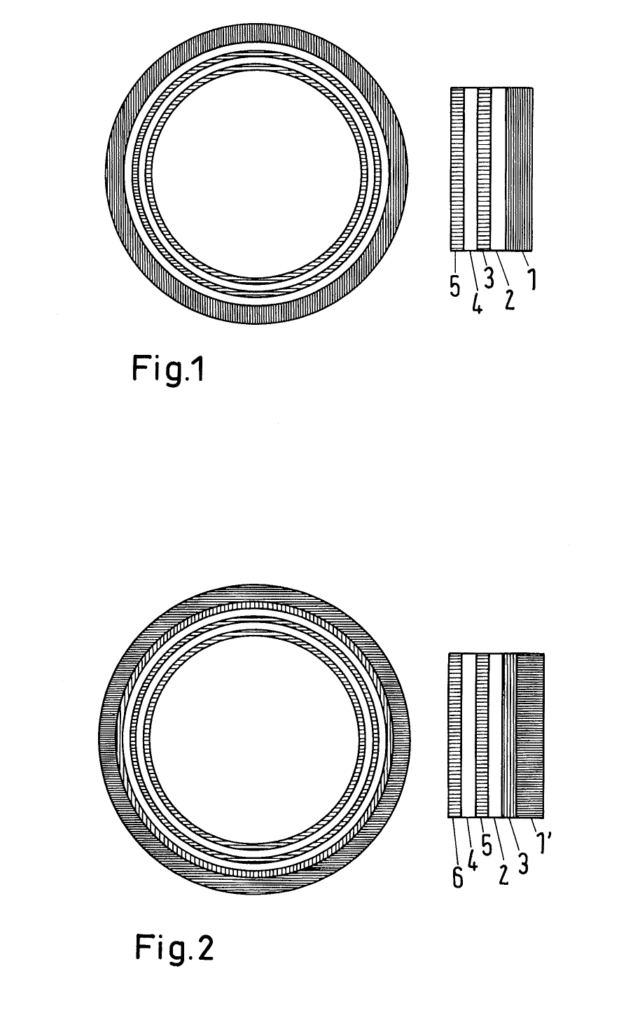

FIG. 2 shows an exemplary embodiment with a metal measuring tube 1′. The measuring tube may be constituted by any metal or metal alloy, such as steel, for example. The layer sequence differs in that the layer 3 directly on the measuring tube 1′ is naturally an insulation layer because the measuring tube is metal. On the other hand, in the case of a plastic measuring tube, the tube 1 is already insulating and the alternating layer sequence thus begins with a conductive layer 3.

However, the principle is the same. With the metal tube 1′, two conductive diagnostic layers 2, 4 thus produce a layer sequence of five layers because there are three insulation layers 3, 5, 6, whereas, with the plastic measuring tube 1, there are only four layers because there are two conductive layers 2, 4 and tow insulating layers 3, 5. It is to be understood that the present disclosure is not limited to the number of layers illustrated in the examples of FIGS. 1 and 2.

The electrically conductive layers in both refinements may be metal layers, electrically conductive layers made of conductive plastic or even thin metal nets or grids, for example.

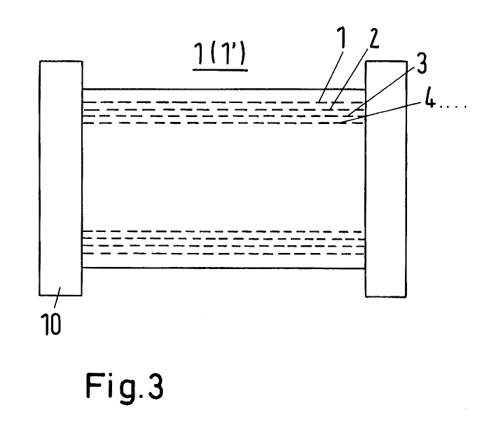

FIG. 3 shows a side view of a measuring tube for a flowmeter. Flanges 10 which can be used to install the measuring tube in a process pipeline are arranged on both sides.

The individual electrically conductive layers 2, 4 in the internally lining layer sequence of the measuring tube 1, 1′ are contact-connected, for example, by means of vapor-deposited connecting lugs. The contact-connection is routed to outside of the measuring tube 1, 1′ and is connected to a measuring device. The latter detects a change in the conductivity or the electrical capacitance if the measurement medium comes into electrical contact with the conductive layer 2, 4 as a result of abrasion of the respective insulating covering layer 3, 5, or if a change in the capacitance needs to be detected in the case of capacitive measurement. In the case of capacitive measurement, the respective conductive layer 2, 4 acts like an electrode and the insulating layer 3, 5 applied thereto acts like a dielectric. It is thus possible, even in the case of an insulation layer 3, 5 which is becoming thinner, to detect a change before abrasion with electrical contact results.

In view of the above-described exemplary embodiments, features of the present disclosure can encompass and be applicable to the metal measuring tubes that have an insulating internal lining as well as plastic measuring tubes.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A flowmeter having a measuring tube internally lined with plastic, the flowmeter comprising:
at least one electrode arranged to be in contact with a measurement substance to be measured; and
a plurality of layers arranged in a layered sequence of insulating plastic layers and conductive layers.

2. The flowmeter as claimed in claim 1, wherein the conductive layers comprise at least one metal layer.

3. The flowmeter as claimed in claim 1, wherein the conductive layers comprise at least one electrically conductive plastic layer.

4. The flowmeter as claimed in claim 2,
comprising a measuring device configured to measure an electrical reaction of at least one of the layers, and output notification of an electrical short circuit,
wherein an innermost layer of the plurality of layers is an electrically insulating plastic layer, and a layer adjacent to the innermost layer is a conductive layer which is contact-connected and connected to the measuring device,
the measuring device being configured to output notification of an electrical short circuit in case the measurement medium comes into contact with the conductive layer as a result of an abrasion of said innermost insulation layer.

5. The flowmeter as claimed in claim 1, wherein the measuring tube is comprised of metal, and the plurality of layers are arranged on an inside periphery of the measuring tube.

6. The flowmeter as claimed in claim 1, wherein the measuring tube is comprised of plastic, and the plurality of layers are arranged on an inside periphery of the measuring tube.

7. The flowmeter as claimed in claim 1, wherein at least one of the insulation layers is arranged under one of the conductive layers, and a further conductive diagnostic layer is arranged under said insulation layer.

8. The flowmeter as claimed in claim 7, wherein the measuring tube is comprised of metal, and a further insulation layer is arranged between said further conductive diagnostic layer and an inner peripheral wall of the measuring tube.

9. The flowmeter as claimed in claim 7, wherein the measuring tube is comprised of plastic, and said further conductive diagnostic layer is arranged directly on an inner peripheral wall of the measuring tube.

10. The flowmeter as claimed in claim 3,
comprising a measuring device configured to measure an electrical reaction of at least one of the layers, and output notification of an electrical short circuit,
wherein an innermost layer of the plurality of layers is an electrically insulating plastic layer, and a layer adjacent to the innermost layer is a conductive layer which is contact-connected and connected to the measuring device,
the measuring device being configured to output notification of an electrical short circuit in case the measurement medium comes into contact with the conductive layer as a result of an abrasion of said innermost insulation layer.

11. The flowmeter as claimed in claim 4, wherein the measuring tube is comprised of metal, and the plurality of layers are arranged on an inside periphery of the measuring tube.

12. The flowmeter as claimed in claim 1, wherein the flowmeter has a substantially circular shape, and the layered sequence is arranged on an inside periphery of the flowmeter.

13. The flowmeter as claimed in claim 12, wherein the insulating plastic layers and conductive layers are arranged alternately on the inside periphery of the measuring tube.

14. The flowmeter as claimed in claim 1, wherein the insulating plastic layers and conductive layers are arranged alternately on an inside periphery of the measuring tube.

15. The flowmeter as claimed in claim 4, wherein the measuring tube is comprised of plastic, and the plurality of layers are arranged on an inside periphery of the measuring tube.

16. The flowmeter as claimed in claim 1, wherein the measuring tube is comprised entirely of plastic, and the insulating plastic layers and conductive layers are arranged alternately on an inside periphery of the measuring tube.

17. The flowmeter as claimed in claim 16, wherein one of the conductive layers is an innermost layer arranged directly on the inside periphery of the measuring tube.

18. The flowmeter as claimed in claim 1, wherein the measuring tube is comprised of metal, and the insulating plastic layers and conductive layers are arranged alternately on an inside periphery of the measuring tube.

19. The flowmeter as claimed in claim 18, wherein one of the insulating layers is an innermost layer arranged directly on the inside periphery of the measuring tube.
